(19) United States
(12) Patent Application Publication
(10) Pub. No.: US 2021/0372320 A1
(43) Pub. Date: Dec. 2, 2021

(54) SENSOR UNIT FOR A LENGTH-ADJUSTABLE CONNECTING ROD

(71) Applicants: IWIS MOTORSYSTEME GMBH & CO. KG, München (DE); AVL LIST GMBH, Graz (AT)

(72) Inventor: Karim ELWAN, München (DE)

(21) Appl. No.: 16/968,137

(22) PCT Filed: Feb. 26, 2019
(86) PCT No.: PCT/EP2019/054745

§ 371 Date: Aug. 6, 2020

(30) Foreign Application Priority Data
Feb. 26, 2018 (DE) 10 2018 104 292.2

(51) Int. Cl. F02B 75/04; F02D 15/02; G01B 21/02

(52) U.S. Cl. CPC F02B 75/045; G01B 21/02; F02D 15/02

(57) ABSTRACT

A device for an internal combustion engine, in particular a spark ignition engine, with a length-adjustable connecting rod and a sensor unit for detecting the adjustment in length of the connecting rod is provided. The length-adjustable connecting rod comprises a first connecting rod member for receiving a piston pin and a second connecting rod member for receiving a crankshaft journal, where the distance in length between the piston pin and the crankshaft journal is adjustable by way of the connecting rod. The sensor unit comprises a sensor and an index region provided on the length-adjustable connecting rod, where a property of the index region that is dependent upon the adjustment in length of the connecting rod can be detected by way of the sensor. An internal combustion engine with such a device, comprises a length-adjustable connecting rod and a sensor unit as well as the use of such a sensor unit and a length-adjustable connecting rod.

The present invention relates to a device for an internal combustion engine, in particular a spark ignition engine, with a length-adjustable connecting rod which comprises a first connecting rod end for receiving a piston pin and a second connecting rod end for receiving a crankshaft journal, where the length between the piston pin and the crankshaft journal is adjustable by way of the connecting rod. The invention further relates to an internal combustion engine with such a length-adjustable connecting rod as well as the use of a length-adjustable connecting rod and a sensor unit in an internal combustion engine.

The thermal degree of efficiency of an internal combustion engine, in particular of spark ignition engines, is dependent upon the compression ratio ε, i.e. the ratio of the total volume prior to compression to the compression volume (ε==(displacement volume Vₕ+compression volume V_{c}) compression volume V_{c}). As the compression ratio increases, the thermal efficiency increases. The increase in the thermal efficiency over the compression ratio is degressive, but still relatively pronounced in the range of values that are typical nowadays.

In practice, the compression ratio cannot be increased arbitrarily, since too high a compression ratio leads to unintentional self-ignition of the combustion mixture due to an increase in pressure and temperature. This early combustion does not only lead to spark ignition engines not running smoothly and so-called knocking, but can also lead to component damage in the engine. In the partial load range, the risk of self-ignition is lower, which, in addition to the influence of ambient temperature and the pressure, also depends on the operating point of the engine. Accordingly, a higher compression ratio is possible in the partial load range. Efforts to match the compression ratio to the respective operating point of the engine have therefore been made in the development of modern combustion engines.

In order to prevent knocking of the engine in the upper load range, the sound vibrations in the engine are detected by a knock sensor, typically a piezoelectric receiver, and, when high-frequency vibration components typical for knocking occur, then the ignition timing is adjusted in the late direction by the engine control unit until knocking noise can no longer be determined. The engine control unit then gradually again advances the ignition timing in the direction of an early ignition point in order to obtain better use of the fuel and thus better efficiency of the engine. This keeps the internal combustion engine permanently close to the so-called knocking limit. In addition to the highest possible power output and optimal engine efficiency, such electronic knock control compensates for fluctuations in fuel quality and prevents engine damage.

Various solutions exist for the realization of a variable compression ratio (VCR) with which the position of the crankshaft journal of the crankshaft or the piston pin of the engine piston is varied or the effective length of the connecting rod is varied. There are respective solutions for continuous and discontinuous adjustment of the components. Continuous adjustment makes it possible to reduce CO₂ emissions and fuel consumption due to a compression ratio which can be adjusted for every operating point. On the other hand, discontinuous adjustment with two steps designed as end stops of the adjustment motion allows for structural and operational advantages and still allows for significant savings in fuel consumption and CO₂ emissions compared to a conventional crankshaft drive.

U.S. Pat. No. 2,217,721 already describes an internal combustion engine with a length-adjustable connecting rod with two rod members which can be telescoped into one another and together form a high-pressure space. For filling the high-pressure space with and emptying it of engine oil and thus for changing the length of the connecting rod, a hydraulic adjustment mechanism is provided with a control valve which can be adjusted by the pressure of the engine oil.

Discontinuous adjustment of the compression ratio for an internal combustion engine is shown in EP 1 426 584 A1 in which an eccentric connected to the piston pin enables adjustment of the compression ratio. In this case, the eccentric is fixed at the one or the other end position of the pivoting range by use of a mechanical locking mechanism. DE 10 2005 055 199 A1 also discloses the mode of operation of a variable length connecting rod with which different compression ratios are obtained. There as well, the implementation is done by way of an eccentric in the connecting rod small end which is fixed in position by two hydraulic cylinders with variable resistance.

WO 2013/092364 A1 describes a length-adjustable connecting rod for an internal combustion engine with two rod members that are telescopically slidable into each other, one rod member forming a cylinder and the second rod member forming a piston element that is slidable in the length direction. A high-pressure space is formed between the adjustable piston of the first rod member and the cylinder of the second rod member and is supplied with engine oil via a hydraulic adjustment mechanism. A similar length-adjustable connecting rod for an internal combustion engine with a telescopically slideable rod members is shown in WO 2015/055582 A2.

The adjustable connecting rod of such length-adjustable connecting rods has influence on the compression volume in the combustion chamber, where the displacement volume is defined by the position of the crankshaft journal and the cylinder bore. A short position of the connecting rod therefore leads to a smaller compression ratio than a long position of the connecting rod, with otherwise identical geometric dimensions, e.g. piston, cylinder head, crankshaft, valve timing, etc. In many known length-adjustable connecting rods, the connecting rod length is varied hydraulically between two positions, where the change in length is effected by way of a telescopic mechanism which is adjustable using a double-acting hydraulic cylinder. The first connecting rod small end, typically for receiving the piston pin, is connected to a piston rod (telescopic rod member). The associated adjustable piston is guided in an axially slideable manner in a cylinder which is arranged in the connecting rod member with the second connecting rod large end, typically for receiving the crankshaft journal. The adjustable piston separates the cylinder into two pressure spaces, an upper and a lower pressure space. These two pressure spaces are supplied with engine oil via a hydraulic adjustment mechanism, where the latter is supplied with engine oil from the lubrication of the connecting rod bearing. For this purpose, an oil channel is required from the crankshaft journal via the connecting rod bearing to the connecting rod and there via the check valves of the adjustment mechanism into the pressure spaces.

When the connecting rod is in the long position, there is no engine oil in the upper pressure space. The lower pressure space, however, is completely filled with engine oil. During operation, the connecting rod is subjected to alternating pull and push forces due to the gas and mass forces. In the long position of the connecting rod, a pull force is absorbed by mechanical contact with an upper stop of the adjustable piston. As a result, the connecting rod length does not change. A push force applied is transmitted via the piston surface to the lower pressure space filled with oil. Since the check valve of this space prevents oil return, the oil pressure rises, where very high dynamic pressures of well over 1,000 bar can arise in the lower pressure space. The connecting rod length does not change. The connecting rod is hydraulically locked in this direction by the system pressure.

In the short position of the connecting rod, the situation is reversed. The lower pressure space is empty, the upper pressure space is filled with engine oil. A pull force causes a pressure increase in the upper pressure space. A push force is absorbed by a mechanical stop.

The forces to be transmitted in a combustion engine by a connecting rod are substantial, which is why the mechanical load on the eccentric unit in the case of eccentric adjustment and the pressures in the pressure chambers of the cylinder-piston assembly in the case of hydraulic adjustment can be considerable. In view of the high mechanical or hydraulic load on the respective adjustment mechanisms, the fatigue strength of the materials used, the resilience of the components, and the integration into the internal combustion engine are critical. This overall problem implies the risk of a malfunction in the adjustment in length of the connecting rod, which can lead to damage to the internal combustion engine or even to total failure.

Although piston stroke engines are well-known in many fields of technology, and reciprocating piston engines are constantly optimized, improved and further developed in the automotive industry, the hydraulic adjustment and supply mechanisms of cylinder-piston assemblies of the length-adjustable connecting rods continue to be in need of development despite extensive development and research work, in particular, in terms of the necessary functional reliability of length-adjustable connecting rods over the entire operating time of combustion engines. In modern internal combustion engines, the use of knock sensors and the measurement of high-frequency sound vibrations in combination with a knock control and the adjustment of the ignition timing enable optimization of the engine performance in the respective load range of the engine. A knock sensor can also provide information about the position of the reciprocating piston or the correct operation of the length-adjustable connecting rod. In combination with a knock control, however, a knock sensor cannot reliably detect a malfunction of the length-adjustable connecting rod, which can lead not only to permanent defects in the length-adjustable connecting rod, but also to a total failure of the engine.

The present invention is therefore based on the object of providing a device for an internal combustion engine with a length-adjustable connecting rod which enables safe operation of the engine and the length-adjustable connecting rod.

According to the invention, this object is satisfied in that the device comprises a sensor unit for detecting the adjustment in length of the connecting rod, where the sensor unit comprises a sensor and an index region provided on the length-adjustable connecting rod, and where a property of the index region that is dependent upon the adjustment in length of the connecting rod is detectable by the sensor. The detection of the adjustment in length of the connecting rod in the internal combustion engine makes it possible to determine the switching position of the connecting rod during operation of the length-adjustable connecting rod, i.e. whether the connecting rod is in the long position or in the short position. The position of the piston in the cylinder of the internal combustion engine changes in dependence of the short or long position of the connecting rod and thus increases or decreases the compression volume of the combustion chamber. This makes it possible to optimize the degree of efficiency of the engine in partial load and full load operation as well as to monitor the operation of the length-adjustable connecting rod in order to avoid damage to the engine. The index region on the length-adjustable connecting rod serves as a passive or active signal transmitter for the sensor. The index region is arranged in dependence of the sensor and configured such that it makes a physical, chemical, geometric or material property of the index region or the connecting rod in the index region that is dependent upon the adjustment in length be detectable. The shape or structure of the index region depends on the sensor selected and the associated sensitivity and resolution of the sensor. Since the position of the connecting rod changes regularly during operation of the internal combustion engine, the values detected by the sensor must be evaluated in dependence of the position of the crankshaft journal or measurement data is only recorded when the crankshaft journal is in a defined position.

An expedient configuration provides that the sensor is an optical, inductive, capacitive or acoustic sensor. Such sensors are available in different designs, qualities and accuracies and corresponding measurement concepts are available in technology. Despite the possibility of using inexpensive sensors from the field of optical, inductive, capacitive or acoustic sensors, these sensors enable the problem-free and exact measurement of the adjustment in length of the connecting rod. The sensor can in particular be a contactless, preferably an optical, inductive, capacitive or acoustic distance sensor, in order to thus obtain an easily detectable and further processable signal with the sensor unit.

An advantageous configuration provides that the index region be formed on a surface of the length-adjustable connecting rod. An index region formed on the surface of the length-adjustable connecting rod can be provided inexpensively during manufacture of the length-adjustable connecting rod, but can also be attached in a subsequent work step. The index region can in particular be provided in a region of the connecting rod that exhibits a significant change in position relative to the sensor when the connecting rod is adjusted in length. According to the physical, chemical, geometric, or material properties of the index region detected by the sensor during the adjustment in length of the connecting rod, the index region can comprise a simple surface of the connecting rod, a specially designed or reworked contour, a geometric structure provided on the connecting rod or passing through it, an inductive resistor embedded in the connecting rod, a magnet embedded in the connecting rod, or another alternative configuration of the index region.

A particular configuration provides that the index region on the length-adjustable connecting rod has a structured surface, preferably a surface with projections projecting in the direction of the distance sensor. A structured surface enables clear and unambiguous detection of the index region, especially in connection with a contactless optical or acoustic distance sensor. Projections projecting in the direction of the distance sensor can create a greater divergence of the measurement signal in critical measuring ranges of the adjustment in length of the connecting rod and thus enable more precise measurement. For example, a surface with a rectangular profile can have a step, in particular in the region of a transition between sufficient and insufficient adjustment in length, that leads to a clear measurement signal.

For reliable and continuous operation of the adjustment in length of the connecting rod in an internal combustion engine, the length-adjustable connecting rod can comprise at least a first connecting rod member with the first connecting rod end and a second connecting rod member with the second connecting rod end, where the first connecting rod member can be attached in the longitudinal direction of the connecting rod relative to the second connecting rod member to adjust the distance between the piston pin and the crankshaft journal, and where the index region is arranged on the second connecting rod member for receiving the crankshaft journal. Such connecting rod members which are movable in the longitudinal direction, can preferably be telescoped, prevent a translatory motion of the first connecting rod member in the region of the piston pin, a corresponding eccentric mount of the piston pin and a high bearing load. Due to the eccentric-free mounting of the piston pin in the first connecting rod member, the adjustment in length is effected exclusively in the region of the connecting rod, so that the position of the connecting rod changes in dependence of its adjustment in length. while the angular position of the crankshaft journal relative to the engine housing remains the same. This change in position in dependence of the position of the crankshaft journal can be clearly detected by the sensor and the connecting rod length can be determined therefrom independently of other engine parameters. Furthermore, the adjustment in length of the connecting rod also leads to a different angular position, in particular of the second connecting rod member, relative to the same angular position of the crankshaft journal, which can be detected by a suitable sensor and used to determine the connecting rod length. Alternatively, the connecting rod can also have an eccentric section, in particular in the connecting rod small end for receiving the piston pin, in order to adjust the distance between the piston pin and the crankshaft journal, where the index region can be arranged on the connecting rod itself or on the adjustment levers of the eccentric section.

An advantageous configuration provides that at least one cylinder-piston assembly is provided for moving the first connecting rod member relative to the second connecting rod member, where the first connecting rod member is connected to an adjustable piston of the cylinder-piston assembly and the second connecting rod member is a cylinder bore of the cylinder-piston assembly. Such a cylinder-piston assembly not only enables hydraulically actuated adjustment of the connecting rod with activation via the engine oil circuit of the internal combustion engine, but also a simple configuration of the index region on the surface of the connecting rod, on the contour or geometric structure of the connecting rod, or within the connecting rod itself. For arranging and receiving the adjustable piston in the cylinder bore, the second connecting rod member can comprise a corresponding cylinder housing on which a simple, reproducible arrangement of the index region is possible during manufacture or thereafter. Furthermore, the first connecting rod member connected to the adjustable piston can optionally comprise a piston rod.

Another modification provides that the sensor unit comprise a control device which is coupled to the sensor for detecting the property of the index region which is dependent upon the adjustment in length of the connecting rod. Depending on the measured value of the sensor and the position of the crankshaft journal, not only the position or the length of the connecting rod can be determined by way of the control device, but the control unit can also actively control the measurement of the sensor unit. For this purpose, the control device can trigger the measurement by the sensor at a specific angular position of the crankshaft journal. Depending on the engine power provided by an engine control device, the control device can additionally verify whether the adjustment in length of the connecting rod corresponds to the specified operating settings. Should the control device detect a deviation that is not corrected over a certain number of cycles, then the output of a corresponding signal via an interface can indicate the defect or, depending on the type of defect, take the engine to a safe operating position.

Furthermore, the invention relates to the use of a sensor unit for detecting the adjustment in length of a length-adjustable connecting rod with an index region provided on the length-adjustable connecting rod and a sensor, preferably a contactless distance sensor, where the length-adjustable connecting rod comprises a first connecting rod member for receiving a piston pin and a second connecting rod member for receiving a crankshaft journal, and where the distance between the piston pin and the crankshaft journal is adjustable and the sensor detects a property of the index region that is dependent upon the adjustment in length of the connecting rod, preferably the distance between the index region and the sensor. Such a sensor unit makes it possible to determine the switching position of the connecting rod during the operation of the internal combustion engine. For the employment of a distance sensor, the index region is preferably formed on the surface of the connecting rod. In combination with a suitable control unit, the adjustment in length of the connecting rod can be determined independently of other performance data of the internal combustion engine.

In addition, the invention also relates to the use of a length-adjustable connecting rod with an index region in an internal combustion engine, where a sensor, preferably a contactless distance sensor, detects a property of the index region that is dependent upon the adjustment in length of the connecting rod, preferably the distance between the index region on the length-adjustable connecting rod and the distance sensor affixed relative to the internal combustion engine. This not only enables an adjustment of the compression ratio in the internal combustion engine, but also reliable monitoring of the operation of the length-adjustable connecting rod.

In one further aspect, the invention relates to an internal combustion engine with at least one piston or a reciprocating piston moving in the cylinder, as well as with at least one adjustable compression ratio in a cylinder, a length-adjustable connecting rod that is connected to the reciprocating piston, and sensor unit according to the above-described device. All reciprocating pistons of an internal combustion engine are preferably equipped with such a length-adjustable connecting rod and a sensor unit, but this is not required. The fuel saving effect of such an internal combustion engine can be considerable when the compression ratio is adjusted accordingly in dependence of the respective operating condition. Advantageously, the cylinder-piston assembly of the length-adjustable connecting rod may be connected to the engine oil hydraulics of the internal combustion engine in order to effect the adjustment in length of the connecting rod. The adjustment in length of the connecting rod can be detected by way of the sensor unit and, if necessary, processed via a control device.

Furthermore, the invention relates to a method for detecting the adjustment in length of a length-adjustable connecting rod with an index region provided on the length-adjustable connecting rod, a sensor, in particular a contactless distance sensor, and a control device, comprising detecting by way of the sensor a property of the index region that is dependent upon the adjustment in length of the connecting rod, in particular detecting the distance between the index region and the distance sensor, comparing the detected property of the index region with a reference value in the control device, and calculating the adjustment in length or the switching position of the connecting rod by way of the control device. In addition to the simple detection of the current switching position of the length-adjustable connecting rod, a deviation from the switching position to be expected can also be determined in dependence of parameters and performance data of the internal combustion engine and a corresponding warning signal can be generated. Furthermore, the parameters and the performance data of the internal combustion engine enable a positionally accurate measurement of the property of the index region in dependence of the angular position of the crankshaft.

In the following, an embodiment shall be explained in more detail with reference to a drawing, where:

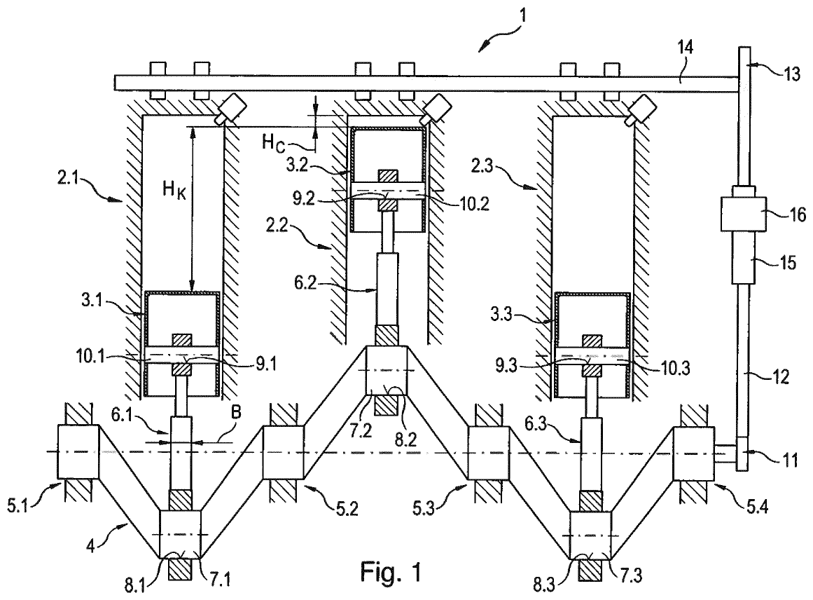

FIG. 1 shows a schematic cross-sectional view through an internal combustion engine, and

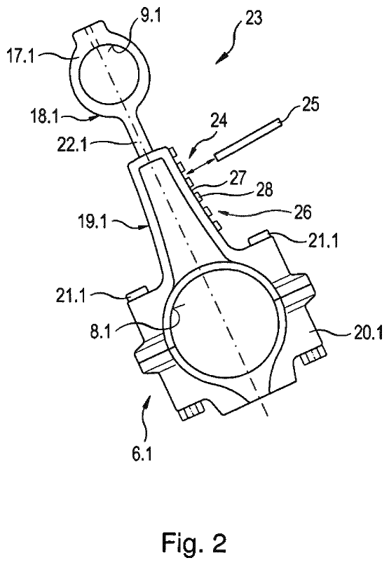

FIG. 2 shows a side view of a device according to the invention for an internal combustion engine with a length-adjustable connecting rod and a sensor unit,

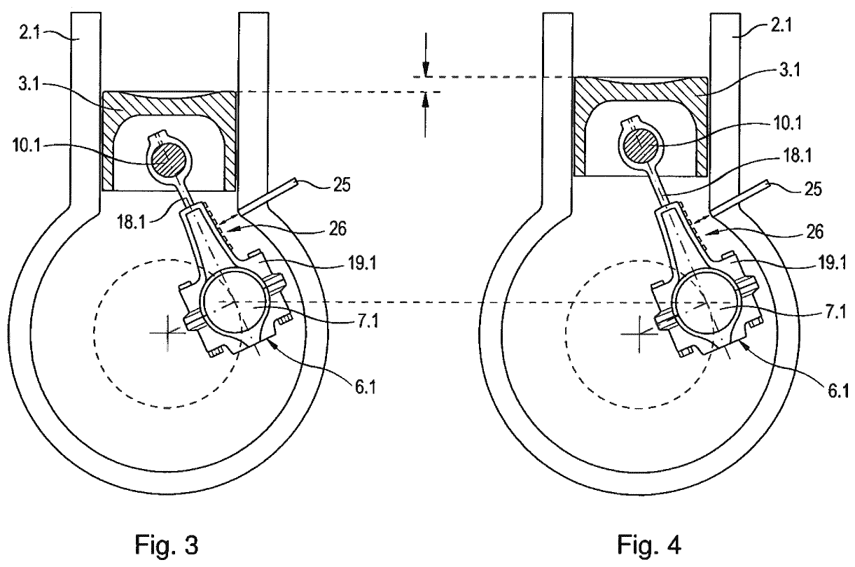

FIG. 3 shows a sectional view through the internal combustion engine from FIG. 1 along a length-adjustable connecting rod in a short position and

FIG. 4 shows a sectional view through the internal combustion engine from FIG. 1 along a length-adjustable connecting rod in a long position.

FIG. 1 shows a schematic representation of an internal combustion engine (spark ignition engine) 1. Internal combustion engine 1 has three cylinders 2.1, 2.2 and 2.3, in each of which a reciprocating piston 3.1, 3.2, 3.3 moves up and down. Furthermore, internal combustion engine 1 comprises a crankshaft 4 which is rotatably mounted by way of crankshaft bearings 5.1,5.2, 5.3 and 5.4. Crankshaft 4 is connected to associated reciprocating pistons 3.1, 3.2 and 3.3 by way of respective connecting rods 6.1, 6.2 and 6.3. Crankshaft 4 comprises an eccentrically arranged crankshaft journal 7.1, 7.2 and 7.3 for each connecting rod 6.1, 6.2 and 6.3. Second connecting rod end 8.1, 8.2, and 8.3 is respectively supported on associated crankshaft journal 7.1, 7.2 and 7.3 First connecting rod end 9.1, 9.2 and 9.3 is respectively mounted on a piston pin 10.1, 10.2 and 10.3 and is thus pivotally connected to associated reciprocating piston 3.1, 3.2 and 3.3. In technical parlance, first connecting rod ends 9.1, 9.2 and 9.3 receiving piston pins 10.1, 10.2 and 10.3 are referred to as the connecting rod small end and second connecting rod ends 8.1.8.2 and 7.3 receiving crankshaft journals 7.1.7.2 and 7.3 are referred to as the connecting rod large end, where no absolute or relative size association can be derived from these terms, but they only serve to differentiate the components and the association to the internal combustion engine shown in FIG. 1. Accordingly, the dimensions of the diameters of first connecting rod ends 9.1, 9.2 and 9.3 can be smaller, equal or larger than the dimensions of the diameters of second connecting rod ends 8.1, 8.2 and 8.3.

Crankshaft 4 is provided with a crankshaft sprocket 11 and coupled to a camshaft sprocket 13 by way of a timing chain 12. Camshaft sprocket 13 drives a camshaft 14 with its associated cams for operating the intake and exhaust valves (not shown in detail) of each cylinder 2.1, 2.2 and 2.3. The return span of timing chain 12 is tensioned by use of a pivotally arranged tensioning rail 15 which is pressed thereagainst by way of a chain tensioner 16. The drive span of timing chain 12 can slide along a guide rail. The essential mode of operation of this timing system, including fuel injection and ignition by way of a spark plug, shall not be explained in detail and is assumed to be known. The eccentricity of crankshaft journals 7.1, 7.2 and 7.3 substantially determines the stroke H_{K}, in particular where, as presently, crankshaft 4 is arranged exactly centrically beneath cylinders 2.1, 2.2 and 2.3. Reciprocating piston 3.1 is shown in its lowermost position in FIG. 1, whereas reciprocating piston 3.2 is shown in its uppermost position. The difference presently defines stroke the H_{K}. The remaining height H_{c} (see cylinder 2.2) determines the remaining compression height in cylinder 2.2. In connection with the diameter of reciprocating piston 3.1, 3.2 or 3.3 or associated cylinders 2.1, 2.2 and 2.3, respectively, the displacement Vₕ is obtained from the stroke H_{K} and the compression volume V_{c} is calculated from the remaining compression height H_{c}. The compression volume V_{c} is of course decisively dependent on the design of the cylinder cover. The compression ratio ε arises from these volumes Vₕ and V_{c}. In detail, the compression ratio ε is calculated from the sum of the displacement volume Vₕ and the compression volume V_{c} divided by the compression volume Vc. Typical values today for spark ignition engines range between 10 and 14.

To allow for the compression ratio ε to be adapted in dependence of the operating point (rotational speed n, temperature T, throttle position) of internal combustion engine 1, connecting rods 6.1, 6.2 and 6.3 are designed to be adjustable in their length. As a result, a higher compression ratio can be obtained in the partial load range than in the full load range.

FIG. 2 shows by way of example a side view of length-adjustable connecting rod 6.1, which is identical to connecting rods 6.2 and 6.3 of internal combustion engine from FIG. 1. The description therefore applies accordingly. Connecting rod 6.1 comprises a first connecting rod member 18.1 with a connecting rod head 17.1 and said first connecting rod end 9.1, where first connecting rod member 18.1 is guided in a telescoped manner in a second connecting rod 19.1. The relative motion of first connecting rod member 18.1 in the longitudinal direction toward second connecting rod member 19.1 is effected in particular by way of a cylinder-piston assembly (not shown) integrated into second connecting rod member 19.1 with an adjustable piston which is movably received in a cylinder bore, as well as a sealing device between the adjustable piston and the cylinder bore. Arranged at second connecting rod member 19.1 is a lower bearing shell 20.1 which, together with the lower portion of second connecting rod member 19.1, surrounds second connecting rod end 8.1. Lower bearing shell 20.1 and second connecting rod member 19.1 are attached to each other with attachment bolts 21.1. First connecting rod member 18.1 between connecting rod head 17.1 and second connecting rod member 19.1 comprises a piston rod 22.1 which is typically connected at the lower end of first connecting rod member 18.1 to the adjustable piston of the cylinder-piston assembly. At the upper end of second connecting rod member 19.1, piston rod 22.1 is slidably inserted into second connecting rod member 19.1 through a correspondingly sealed bore. To change the length of connecting rods 6.1 by way of the cylinder-piston assembly, a hydraulic adjustment mechanism (not shown) is provided which controls the inlet and outlet of the engine oil into and out of the cylinder-piston assembly and thereby causes connecting rod 6.1 to be affixed in the short and long position.

Shown in FIG. 2 are length-adjustable connecting rods 6.1 as well as a sensor unit 24 as parts of device 23 according to the invention. Sensor unit 24 comprises a sensor 25 and an index region 26 provided on second connecting rod member 19.1. The shape and structure of index region 26 is dependent upon sensor unit 24 selected and its arrangement, mode of operation and sensitivity. Sensor 25 detects the distance from index region 26 as indicated by the double arrow between sensor 25 and index region 26 Accordingly, sensor 25 in the embodiment shown is configured as a contactless distance sensor. In the embodiment shown in FIG. 2, index region 26 on the side of second connecting rod member 19.1 facing sensor 25 is configured as a structured surface 27 with several projections 28 projecting rectangularly in the direction of sensor 25.

The sectional view through internal combustion engine 1 in FIG. 3 shows device 23 according to the invention with length-adjustable connecting rod 6.1 in a short position. Sensor 25 is affixed in position in internal combustion engine 1 and detects the distance from index region 26 on second member 19.1 of length-adjustable connecting rod 6.1. FIG. 4 shows device 23 according to the invention from FIG. 3 with length-adjustable connecting rod 6.1 in a long position.

As can be seen from the comparison between Figures. 3 and 4, in a long position of connecting rod 6.1, reciprocating piston 3.1 is inserted deeper into cylinder 2.1 while the angular position of crankshaft 4 or crankshaft journal 7.1 remains the same, so that a higher compression ratio arises during operation in cylinder 2.1 of FIG. 4. In addition to the difference between the position of reciprocating piston 3.1 in cylinder 2.1 due to the adjustment in length of connecting rod 6.1 to the extended long position, the changed distance between second connecting rod member 19.1 and sensor 25 affixed in internal combustion engine 1 is also very clearly evident in FIG. 4. The measured values of sensor 25, in particular a distance measurement to index region 26 on second connecting rod member 19.1, can be detected with a control device (not shown) connected to sensor 25 and be compared with a reference profile. At the same time, the control device can control the measurement of sensor unit 24 in such a way that the measurement takes place only at a specific angular position of crankshaft 4. In addition to the detection of the current position of length-adjustable connecting rod 6.1, the control device can also evaluate the position of connecting rod 6.1 in dependence of parameters and performance data of internal combustion engine 1 from the engine control device and can generate a corresponding signal independently of the engine control device for driver information and for consideration in the operational safety of internal combustion engine 1 if the expected switching position deviates over a certain number of cycles.

### LIST OF REFERENCE NUMERALS

1. internal combustion engine
2.1.2.2.2.3 cylinder
3.1.3.2.3.3 reciprocating piston
4 crankshaft
5.1,5.2,5.3,5.4 crank shaft bearing
6.1.6.2.6.3 connecting rod
7.1.7.2.7.3 crankshaft journal
8.1.8.2.8.3 second connecting rod end
9.1.9.2.9.3 first connecting rod end
10.1.10.2.10.3 piston pin
11 crankshaft sprocket
12 timing chain
13 camshaft sprocket
14 camshaft
15 tensioning rail
16 chain tensioner
17.1 connecting rod head
18.1 first connecting rod member
19.1 second connecting rod member
20.1 bearing shell
21.1 attachment bolt
22.1 piston rod
23 device
24 sensor unit
25 sensorF
26 index region
27 structured surface
28 projections
Vₕ displacement volume
V_{c} compression volume
H_{c} compression height
H_{K} stroke
εcompression ratio
n rotational speed
T temperature

1. A device for an internal combustion engine, in particular a spark ignition engine, with a length-adjustable connecting rod, said length-adjustable connecting rod comprises a first connecting rod end for receiving a piston pin and a second connecting rod end for receiving a crankshaft journal, where the length between said piston pin and said crankshaft journal is adjustable by way of said connecting rod; wherein said device comprises a sensor unit for detecting the adjustment in length of said connecting rod, where said sensor unit comprises a sensor and an index region provided on said length-adjustable connecting rod, and where a property of said index region that is dependent upon the adjustment in length of said connecting rod is detectable by said sensor.

2. The device according to claim 1, wherein said sensor is an optical, inductive, capacitive or acoustic sensor.

3. The device according to claim 1 or 2, characterized in that wherein said sensor is a contactless distance sensor, preferably an optical, inductive, capacitive or acoustic distance sensor.

4. The device according to claim 1, wherein said index region is formed on a surface of said length-adjustable connecting rod.

5. The device according to claim 4, wherein said index region on said length-adjustable connecting rod has a structured surface, preferably a structured surface with projections projecting in the direction of a distance sensor.

6. The device according to claim 1, wherein said length-adjustable connecting rod comprises at least a first connecting rod member with said first connecting rod end and a second connecting rod member with said second connecting rod end, where said first connecting rod member is movable relative to said second connecting rod member in the longitudinal direction of said connecting rod in order to adjust the distance between said piston pin and said crankshaft journal, and where said index region is arranged on said second connecting rod member for receiving said crankshaft journal.

7. The device according to claim 6, wherein at least one cylinder-piston assembly is provided for moving said first connecting rod member relative to said second connecting rod member, where said first connecting rod member is connected to an adjustable piston of the cylinder-piston assembly and said second connecting rod member comprises a cylinder bore of the cylinder-piston assembly.

8. The device according to claim 1, wherein, said sensor unit comprises a control device which is coupled to said sensor for detecting the property of said index region which is dependent upon the adjustment in length of said connecting rod.

9. Use A use of a sensor unit for detecting the adjustment in length of a length-adjustable connecting rod with an index region provided on said length-adjustable connecting rod and a sensor, preferably a contactless distance sensor, where said length-adjustable connecting rod comprises a first connecting rod end for receiving a piston pin and a second connecting rod end for receiving a crankshaft journal, where the distance between said piston pin and said crankshaft journal is adjustable and said sensor detects a property of said index region that is dependent upon the adjustment in length of said connecting rod, preferably the distance between said index region and said sensor.

10. A use of a length-adjustable connecting rod with an index region (26) internal combustion engine (1), where a sensor (6), preferably a contactless distance sensor, detects a property of said index region (25) that is dependent upon the adjustment in length of said connecting rod (26), preferably the distance between said index region (26) on the said length-adjustable connecting rod (6.1) and the distance sensor affixed relative to said internal combustion engine (1).

11. An internal combustion engine with at least one cylinder, a reciprocating piston moving in said cylinder and at least one adjustable compression ratio in a cylinder, and with a length-adjustable connecting rod connected to said reciprocating piston and a sensor unit according to said device according to claim 1.

12. A method for detecting the adjustment in length of a length-adjustable connecting rod with an index region provided on said length-adjustable connecting rod (6.1), a sensor (25) and a control device, comprising the steps of:
detecting by way of said sensor a property of said index region that is dependent upon the adjustment in length of said connecting rod,
comparing the detected property of said index region with a reference value in said control device, and
calculating the adjustment in length of a length-adjustable connecting rod (64) using said control device.

13. The method according to claim 12, where said sensor is a contactless distance sensor, comprising the steps of:
detecting the distance between said index region and said sensor, comparing the distance with a reference value in said control device, and calculating the adjustment in length of a length-adjustable connecting rod using said control device.

14. The method according to claim 12, where said control device triggers the detection by way of said sensor of a property of said index region that is dependent upon the adjustment in length of said connecting rod.
